(19) United States
(12) Patent Application Publication
(10) Pub. No.: US 2026/0287726 A1
(43) Pub. Date: Sep. 24, 2026

(54) NETWORK-CONTROLLED SENSOR NODE AND CONFIGURATION THEREOF

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Andreas NILSSON, Göteborg (SE)

(21) Appl. No.: 19/478,363

(22) PCT Filed: Apr. 27, 2023
(86) PCT No.: PCT/EP2023/061195

§ 371 Date: Oct. 24, 2025

(51) Int. Cl. G01S 13/00; G01S 7/00; G01S 7/02; H04W 4/38

(52) U.S. Cl. CPC G01S 13/003; G01S 7/006; G01S 7/024; H04W 4/38

(57) ABSTRACT

There is provided techniques for configuring a network-controlled sensor node for sensing an object. A method is performed by a network node. The method comprises obtaining a report comprises sensing-related information of the network-controlled sensor node. The sensing-related information at least specifies at least one sensing mode supported by the network-controlled sensor node and at least one sensing technique supported by the network-controlled sensor node. The method comprises providing configuration to the network-controlled sensor node for the sensing of the object. The configuration is based on the supported at least one sensing mode and at least one sensing technique.

### TECHNICAL FIELD

Embodiments presented herein relate to a method, a network node, a computer program, and a computer program product for configuring a network-controlled sensor node for sensing an object. Embodiments presented herein further relate to a method, a network-controlled sensor node, a computer program, and a computer program product for the network-controlled sensor node to be configured for sensing the object.

### BACKGROUND

Some wireless communication networks provide sensing services in diverse application areas, such as detection, ranging and tracking of vulnerable road users, automated guided vehicles, or unmanned aerial vehicles. Sensing can help to improve the position estimation of both active and passive objects. For active objects, whose positions are estimated using cellular signals sensing can be used as a means to make the position estimation more precise, while for passive objects sensing can either be the sole available scheme for determining its position, or sensing data can be fused by data provided by other sensors, such as inertial measurement unit (IMU), onboard light detection and ranging (LIDAR) device, etc.

One objective with joint communication and sensing (JCS) is to share the spectrum efficiently between wireless communication and sensing and/or reuse the existing wireless network infrastructure for sensing. In other words, JCS refers to the introduction of sensing capability as part of a wireless communication networks. Here, sensing refers to radar-like functionalities, i.e., the ability to detect the presence, the movement, and the other characteristics of an objects that is under the coverage of a wireless network. Compared to the deployment of a separate network for sensing functionality, one benefit of JCS is that the sensing capability can be introduced on large scale at a relatively low incremental cost by reusing the infrastructure that is deployed for communication purposes. In general terms, sensing involves transmitting a sensing signal towards the object to be sensed, and receiving a reflection of the sensing signal, which is then processed, For mono-static sensing the transmission of the sensing signal and the reception of the reflected sensing signal are handled by the same node.

For multi-static sensing, the transmission and the reception can be handled by different collaborating nodes. One common type of multi-static sensing is bi-static sensing where one node transmits the sensing signal and another node receives the reflection of the sensing signal.

Mono-static sensing typically requires full duplex capability at the node performing the sensing. This is intuitively because in a typical sensing scenario the sensing range may be in the order of tens to hundreds of meters and, thereby, the reflected wave may be received within a fraction of a microseconds which is shorter than in typical data communication systems with larger time scales (in the order of tens of microseconds). Full duplex, however, may be challenging as it requires high level of self-interference cancellation. With bi-static (or, in general multi-static) sensing, on the other hand, full duplex is not required as the signal is transmitted and received by different nodes.

Due to issues with full duplex operation in current wireless networks, mono-static sensing will be challenging for current network equipment (such as network nodes, user equipment, network-controlled repeaters, etc.) and instead bi-static sensing might become more common in communication networks, where one node (such as a network node) is transmitting the sensing signal, and another node (such as another network node, or a user equipment) receives the reflected sensing signal.

However, using regular transmission and reception points for the sensing is expensive since this requires many transmission and reception points to be deployed. Further, this also is cumbersome since this requires coordination between the transmission and reception points.

### SUMMARY

An object of embodiments herein is to address the above issues.

A particular object is to enable sensing of objects without having to deploy extra regular transmission and reception points for this purpose.

A particular object is to introduce dedicated sensing nodes in the network that can be controlled by the network.

A further particular object is to enable network nodes to properly configure the sensing nodes for sensing an object.

According to a first aspect there is presented a method for configuring a network-controlled sensor node for sensing an object. The method is performed by a network node. The method comprises obtaining a report comprises sensing-related information of the network-controlled sensor node. The sensing-related information at least specifies at least one sensing mode supported by the network-controlled sensor node and at least one sensing technique supported by the network-controlled sensor node. The method comprises providing configuration to the network-controlled sensor node for the sensing of the object. The configuration is based on the supported at least one sensing mode and at least one sensing technique.

According to a second aspect there is presented a network node for configuring a network-controlled sensor node for sensing an object. The network node comprises processing circuitry. The processing circuitry is configured to cause the network node to obtain a report comprises sensing-related information of the network-controlled sensor node. The sensing-related information at least specifies at least one sensing mode supported by the network-controlled sensor node and at least one sensing technique supported by the network-controlled sensor node. The processing circuitry is configured to cause the network node to provide configuration to the network-controlled sensor node for the sensing of the object. The configuration is based on the supported at least one sensing mode and at least one sensing technique.

According to a third aspect there is presented a network node for configuring a network-controlled sensor node for sensing an object. The network node comprises an obtain module configured to obtain a report comprises sensing-related information of the network-controlled sensor node. The sensing-related information at least specifies at least one sensing mode supported by the network-controlled sensor node and at least one sensing technique supported by the network-controlled sensor node. The network node comprises a provide module configured to provide configuration to the network-controlled sensor node for the sensing of the object. The configuration is based on the supported at least one sensing mode and at least one sensing technique.

According to a fourth aspect there is presented a computer program for configuring a network-controlled sensor node 30 for sensing an object. The computer program comprises computer code which, when run on processing circuitry of a network node, causes the network node to perform actions. One action comprises the network node to obtain a report comprises sensing-related information of the network-controlled sensor node. The sensing-related information at least specifies at least one sensing mode supported by the network-controlled sensor node and at least one sensing technique supported by the network-controlled sensor node. One action comprises the network node to provide configuration to the network-controlled sensor node for the sensing of the object. The configuration is based on the supported at least one sensing mode and at least one sensing technique.

According to a fifth aspect there is presented a method for a network-controlled sensor node to be configured for sensing an object. The method is performed by the network-controlled sensor node. The method comprises providing a report comprises sensing-related information of the network-controlled sensor node to a network node. The sensing-related information at least specifies at least one sensing mode supported by the network-controlled sensor node and at least one sensing technique supported by the network-controlled sensor node. The method comprises obtaining configuration, from the network node, for the sensing of the object. The method comprises performing sensing of the object in accordance with the obtained configuration.

According to a sixth aspect there is presented a network-controlled sensor node for is configured for sensing an object. The network-controlled sensor node comprises processing circuitry. The processing circuitry is configured to cause the network-controlled sensor node to provide a report comprises sensing-related information of the network-controlled sensor node to a network node. The sensing-related information at least specifies at least one sensing mode supported by the network-controlled sensor node and at least one sensing technique supported by the network-controlled sensor node. The processing circuitry is configured to cause the network-controlled sensor node to obtain configuration, from the network node, for the sensing of the object. The processing circuitry is configured to cause the network-controlled sensor node to perform sensing of the object in accordance with the obtained configuration.

According to a seventh aspect there is presented a network-controlled sensor node for is configured for sensing an object. The network-controlled sensor node comprises a provide module configured to provide a report comprises sensing-related information of the network-controlled sensor node to a network node. The sensing-related information at least specifies at least one sensing mode supported by the network-controlled sensor node and at least one sensing technique supported by the network-controlled sensor node. The network-controlled sensor node comprises an obtain module configured to obtain configuration, from the network node, for the sensing of the object. The network-controlled sensor node comprises a sense module configured to perform sensing of the object in accordance with the obtained configuration.

According to an eighth aspect there is presented a computer program for a network-controlled sensor node to be configured for sensing an object. The computer program comprises computer code which, when run on processing circuitry of the network-controlled sensor node, causes the network-controlled sensor node to perform actions. One action comprises the network-controlled sensor node to provide a report comprises sensing-related information of the network-controlled sensor node to a network node. The sensing-related information at least specifies at least one sensing mode supported by the network-controlled sensor node and at least one sensing technique supported by the network-controlled sensor node. One action comprises the network-controlled sensor node to obtain configuration, from the network node, for the sensing of the object. One action comprises the network-controlled sensor node to perform sensing of the object in accordance with the obtained configuration.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects address the above issues.

Advantageously, these aspects enable sensing of objects without having to deploy extra regular transmission and reception points for this purpose.

Advantageously, by the network node being made aware of the sensing capabilities of the network-controlled sensor node, the network node is enabled to properly configure the network-controlled sensor node for sensing the object.

Advantageously, this enables the network node to have a better view of the surrounding area and sense the objects' location, direction and/or speed with high accuracy.

Moreover, sensing holes, where the network node alone cannot properly sense any objects, in terms of position, speed, etc., are avoided by using the network-controlled sensor node. In this way, the herein disclosed embodiments enable a low complexity and cost-efficient scheme for sensing objects and therefore for the network node to obtain a better understanding about the general characteristics of the environment.

Advantageously, in turn, this will improve the quality of the wireless communication.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a block diagram of a network-controlled sensor node according to an embodiment;

FIGS. 3 and 4 are flowcharts of methods according to embodiments;

FIG. 5 is a schematic diagram showing functional units of a network node according to an embodiment;

FIG. 6 is a schematic diagram showing functional modules of a network node according to an embodiment;

FIG. 7 is a schematic diagram showing functional units of a network-controlled sensor node according to an embodiment;

FIG. 8 is a schematic diagram showing functional modules of a network-controlled sensor node according to an embodiment; and

FIG. 9 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, using regular transmission and reception points for the sensing is expensive since this requires many transmission and reception points to be deployed. Further, this also is cumbersome since this requires coordination between the transmission and reception points.

According to the herein disclosed embodiments, network-controlled sensor nodes are introduced for sensing an object. Particularly, according to the herein disclosed embodiments, the sensing capabilities of one or more network-controlled sensor nodes are reported to the controlling network node which, in return, properly configures the one or more network-controlled sensor nodes for the sensing operation. This will provide the network node with a second view on the surrounding environment and thereby improve the sensing accuracy.

The embodiments disclosed herein in particular relate to techniques for a network node to configure a network-controlled sensor node for sensing an object and for the network-controlled sensor node to be configured accordingly. In order to obtain such techniques there is provided a network node, a method performed by the network node, a computer program product comprising code, for example in the form of a computer program, that when run on processing circuitry of the network node, causes the network node to perform the method. In order to obtain such techniques there is further provided a network-controlled sensor node, a method performed by the network-controlled sensor node, and a computer program product comprising code, for example in the form of a computer program, that when run on processing circuitry of the network-controlled sensor node, causes the network-controlled sensor node to perform the method.

In general terms, radar and wireless communications technologies, both based on electromagnetic wave propagation, have been key technologies during the last decades although with little interaction with each other. Here, most efforts have been on enabling the coexistence of these technologies with little interference to each other. This has been made possible by, for instance, considering different bandwidths for wireless communication and radar. However, with fifth-generation (5G) telecommunication systems and beyond, wireless communication is moving towards the range of frequencies which were previously used by radars. For instance, some of the radar bands, such as band K (18 GHz-26.5 GHZ) and band Ka (26.5 GHz-40 GHz) are close to or may even overlap mm Wave communication bands, e.g., 28 GHz and 39 GHz. This may cause conflicts and requires coordination. At the same time, sensing is expected to play an important role in, e.g., smart cities, automation, autonomous derive, active safety, etc. Satisfying such huge sensing requirements will be challenging. These are some motivations for JCS systems in which the wireless communication infrastructure and/or spectrum is used to enable sensing functionalities. In this way, not only the conflicts between the sensing and wireless communication functionalities are minimized via coordination but also the implementation cost will be reduced because the sensing functionalities can be performed by reusing the wireless communication infrastructure.

In general, sensing accuracy can be improved by sensing an object from different perspectives and/or directions. Particularly, depending on the object's location and moving direction, there may be sensing holes where the network node alone may not be able to detect the object (or otherwise perform a desired sensing operation). For instance, if the object is moving perpendicularly to the network node (i.e., when the Doppler shift of the line-of-sight signal is zero), it is difficult for the network node to detect the object at all. In another scenario, the reflections of the sensing signal as caused by the object may be ill-suited to be received by the same node as transmitted the sensing signal, since the sensing signal might be predominantly reflected elsewhere. In such cases, it would be useful to have radar-like measurements from another direction as well. One option to have the second view on the objects it to use the existing network nodes assisting the macro base stations (BSs), e.g., relays, integrated access and network (IAB) nodes, etc. Thus, multiple sensing views of an object can be obtained if such nodes are sensing-capable. However, in many cases, for instance the IABs, the nodes are already quite complex and expensive, and it may not be practically possible to add yet another set of functionalities to them.

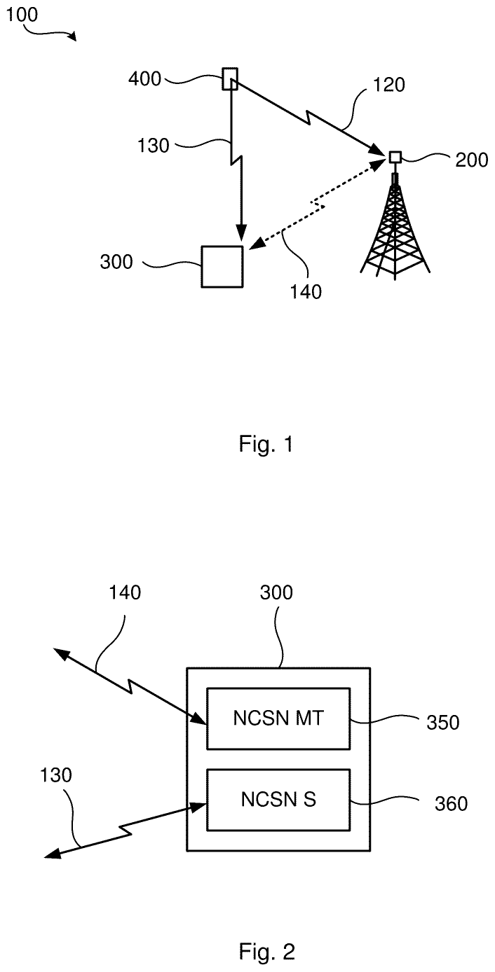

This is one motivation for introducing network-controlled sensor nodes that can be integrated and configured by the network nodes, such as gNBs. In general terms, a network-controlled sensor node can, in some aspects, be regarded as a low-complexity node, possibly with beamforming capabilities, which is under the control of the gNBs and is configured to perform sensing functionalities. The network-controlled sensor nodes, which may or may not be capable of sensing signal processing, receive control information from their controlling gNBs and, thereby, can perform the sensing signal transmission/reception in a more efficient manner. The presence of one or more network-controlled sensor nodes might facilitate bi-static, or in general multi-static, sensing. Reference is here made to the communications network 100 in FIG. 1 where embodiments presented herein can be applied.

The communications network 100 comprises a network node 200 and a network-controlled sensor node 300. The network node 200 and the network-controlled sensor node 300 communicate over a wireless link 140. A sensing signal transmitted over a wireless link 120 from the network node 200 can be reflected by an object 400 and received by the network-controlled sensor node 300 over a wireless link 130. Likewise, a sensing signal transmitted over the wireless link 130 from the network-controlled sensor node 300 can be reflected by the object 400 and received by the network node 200 over the wireless link 120. In some examples, the network node 200 is any of a (radio) access network node, radio base station, base transceiver station, node B (NB), evolved node B (eNB), gNB, access point, access node, IAB node. In some aspects, the network-controlled sensor node 300 is provided in a fixed or portable wireless device, mobile station, mobile phone, user equipment (UE), smartphone, laptop computer, tablet computer, network-equipped vehicle, pico node, or the like. Alternatively, the network-controlled sensor node is provided in a dedicated device.

In FIG. 2 is provided a block diagram of the network-controlled sensor node 300, where interface relevant for the herein disclosed embodiments are illustrated. In this respect, the network-controlled sensor node 300 comprises a network-controlled sensor node mobile termination (NVSN MT) interface 350 and a network-controlled sensor node mobile sensing (NVSN S) interface 360. The NSCN MT interface 350 is configured for the network-controlled sensor node 300 to exchange control information with the network node 200 over the wireless link 140. Thus, the NCSN MT interface 350 might be defined as a functional entity to communicate with the network node 200 via Control link (C-link) to enable the information exchanges. In some examples, the C-link is based on NR Uu interface. The NCSN S interface 360 is configured for the network-controlled sensor node 300 to perform sensing of the objects 400 based on configuration received by the NCSN MT interface 350. The NCSN S interface 360 might thus be defined as a function entity to perform the transmission and/or reception of sensing signals. The behavior of the NCSN S interface 360 will be controlled according to the received control information from the network node 200.

The NCSN MT interface 350 thus supports at least a sub-set of UE functions as it should exchange control information with the controlling network node 200. Also, the NCSN MT interface 350, or some other block in the network-controlled sensor node 300, may or may not have capabilities for sensing signal processing. The NCSN S interface 360 might, on the other hand, be regarded as a transmit and/or receive unit for transmission and/or reception of sensing signals. The NCSN MT interface 350 and the NCSN S interface 360 may share the same set of antennas or be equipped with separate antennas. In some examples, the set of antennas is divided between a first sub-set used for transmission and a second sub-set used for reception. The NCSN MT interface 350 and the NCSN S interface 360 could be operating at the same, different, or overlapping frequencies.

Depending on the sensing capabilities of the network-controlled sensor node 300, the network-controlled sensor node 300 might have different modes of operation.

In some aspects, the network-controlled sensor node 300 operates as the receiver of sensing signals (as transmitted by the network node 200). If the network-controlled sensor node 300 is capable of processing sensing signals, the network-controlled sensor node 300 might also process received sensing signals. Otherwise, received sensing signals might be reported back to the network node 200 for further processing. Here, as an example, the network node 200 may send a sensing signal that is reflected by the object 400 and received by the NCSN S interface 360 of the network-controlled sensor node 300. The network-controlled sensor node 300 might then process the received sensing signal and report information as obtained when processing the received sensing signal back to the network node 200 over the NCSN MT interface 350 or directly report the received sensing signal back to the network node 200.

In some aspects, the network-controlled sensor node 300 operates as the transmitter of sensing signals. Here, the network node 200 sends configurations to the network-controlled sensor node 300 to configure the network-controlled sensor node 300 to send sending signals. The sensing signal is sent by the network-controlled sensor node 300 via the NCSN S interface 360, reflected by the object 400 and received by the network node 200 where the received sensing signal possibly also is processed.

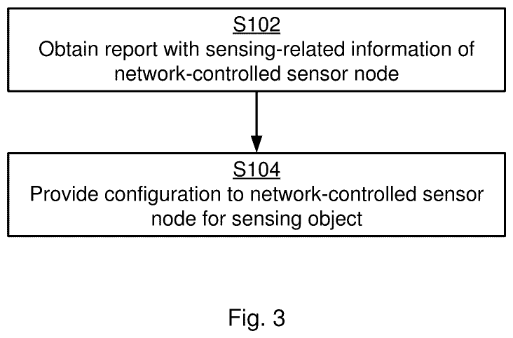

Reference is now made to FIG. 3 illustrating a method for configuring a network-controlled sensor node 300 for sensing an object 400 as performed by the network node 200 according to an embodiment.

S102: The network node 200 obtains a report comprising sensing-related information of the network-controlled sensor node 300. The sensing-related information at least specifies at least one sensing mode supported by the network-controlled sensor node 300 and at least one sensing technique supported by the network-controlled sensor node 300. Examples of sensing modes and sensing techniques will be provided below.

S104: The network node 200 provides configuration to the network-controlled sensor node 300 for the sensing of the object 400. The configuration is based on the supported at least one sensing mode and at least one sensing technique.

The configuration might be a dynamic, semi-static (semi-persistent) configuration. The configuration might be sent using radio resource control (RRC) signaling, medium access control (MAC) control element (CE) signaling, or downlink control information (DCI) signaling.

In this way, based on the sensing-related information of the network-controlled sensor node 300, the network node 200 can properly configure the network-controlled sensor node 300. This will help the network node 200 to have a better view on the objects 400 and surrounding area. This will improve the sensing quality and remove any sensing holes at a low cost.

Embodiments relating to further details of configuring the network-controlled sensor node 300 for sensing an object 400 as performed by the network node 200 will now be disclosed.

There may be different examples of sensing modes. Different embodiments relating thereto will now be described in turn. The supported at least one sensing mode might be any, or any combination, of: monostatic sensing, bistatic sensing, multi-static sensing. Hence, the network-controlled sensor node 300 might perform sensing of the object 400 either by itself, in collaboration with the network node 200, and/or in collaboration with the network node 200 in combination with yet another node, such as another network node 200 or another network-controlled sensor node 300.

There may be different examples of sensing techniques. Different embodiments relating thereto will now be described in turn. The supported at least one sensing technique might be any, or any combination, of: Time-of-Arrival based sensing, Time-Difference-of-Arrival based sensing, Angle-of-Arrival based sensing, Doppler frequency estimation based sensing, channel correlation based sensing, channel state information based sensing.

Further aspects of the sensing-related information will be disclosed next.

In some embodiments, the sensing-related information further specifies any, or any combination, of: polarization mode supported by the network-controlled sensor node 300, type of sensing signals supported by the network-controlled sensor node 300, sensing signal transmission/reception mode supported by the network-controlled sensor node 300, beamforming capabilities of the network-controlled sensor node 300, beam sweeping capabilities (possibly including also beam switching capabilities) of the network-controlled sensor node 300.

In some embodiments, the sensing-related information further specifies any, or any combination, of: output power capabilities of the network-controlled sensor node 300, reception sensitivity of the network-controlled sensor node 300, processing delay of the network-controlled sensor node 300.

In some embodiments, the sensing-related information further comprises positioning information of the network-controlled sensor node 300.

The report with the sensing-related information might in S102 be obtained by being received from the network-controlled sensor node 300, possibly via one or more intermediate nodes, or from an operations, administration, and maintenance (OAM) system.

Further aspects of the configuration will be disclosed next.

In some aspects, the configuration specifies which sensing mode the network-controlled sensor node 300 is to use when performing the sensing. Therefore, in some embodiments, the configuration specifies which supported at least one sensing mode the network-controlled sensor node 300 is to use for sensing the object 400. This configuration is not needed if the network-controlled sensor node 300 only supports one sensing mode.

In some aspects, the configuration specifies which sensing technique to use the network-controlled sensor node 300 is to use when performing the sensing. Therefore, in some embodiments, the configuration specifies which supported at least one sensing technique the network-controlled sensor node 300 is to use for sensing the object 400. This configuration is not needed if the network-controlled sensor node 300 only supports one sensing technique.

In some aspects, the configuration specifies which one or more time and/or frequency resources the network-controlled sensor node 300 is to use when performing the sensing. Here, the one or more time and/or frequency resources to be used for the sensing can be represented by their starting point, ending point, periodicity, duration, etc. Also, the one or more time and/or frequency resources can have a granularity of symbol-level, slot-level, frame-level or indicated with a specific time duration, etc. Therefore, in some embodiments, the configuration specifies time and/or frequency resource for the network-controlled sensor node 300 to use for sensing the object 400.

In some aspects, the configuration specifies if the network-controlled sensor node 300 is to receive and/or transmit sensing signals when performing the sensing. Therefore, in some embodiments, the configuration specifies whether the network-controlled sensor node 300 is to transmit a signal for sensing the object 400, receive a signal for sensing the object 400, or transmit and receive a signal for sensing the object 400.

In some aspects, the configuration specifies how the network-controlled sensor node 300 is to alternate polarization for the NCSN S interface 360 when performing the sensing. Therefore, in some embodiments, the configuration specifies a polarization mode to be used by the network-controlled sensor node 300 when sensing the object 400. In this respect, the network-controlled sensor node 300 might be configured for single-polarization, dual-polarization, and/or alternating polarization.

In some aspects, the configuration specifies which beam configuration (e.g., beamwidth, beam index, etc.) the network-controlled sensor node 300 is to use when performing the sensing. Therefore, in some embodiments, the configuration specifies a beam configuration to be used by the network-controlled sensor node 300 when sensing the object 400.

In some examples, the configuration specifies information about the absolute and/or relative position of the network node 200 and/or the network-controlled sensor node 300. This information might, for example, be useful if the network-controlled sensor node 300 performs processing of the received sensing signals.

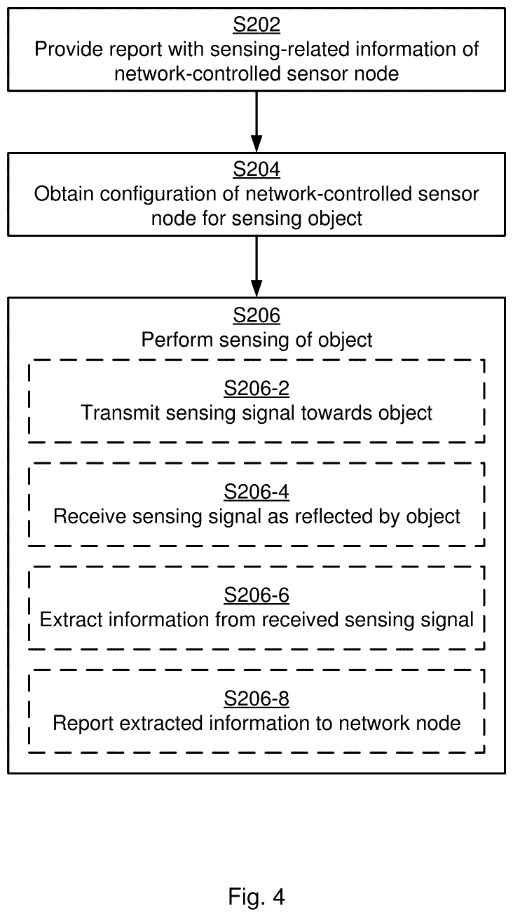

Reference is now made to FIG. 4 illustrating a method for a network-controlled sensor node 300 to be configured for sensing an object 400 as performed by the network-controlled sensor node 300 according to an embodiment.

S202: The network-controlled sensor node 300 provides a report comprising sensing-related information of the network-controlled sensor node 300 to a network node 200. The sensing-related information at least specifies at least one sensing mode supported by the network-controlled sensor node 300 and at least one sensing technique supported by the network-controlled sensor node 300.

The report might be provided via the NCSN MT interface 350. The report might be sent using RRC signaling or MAC-CE signaling.

As disclosed above, the network node 200 might receive the report with sensing-related information either from the network-controlled sensor node 300, possibly via one or more intermediate nodes, or from an OAM system. Therefore, in some embodiments, step S202 is optional.

S204: The network-controlled sensor node 300 obtains configuration, from the network node 200, for the sensing of the object 400.

The configuration might be obtained via the NCSN MT interface 350. As noted above, the configuration might be a dynamic, semi-static or semi-persistent configuration.

S206: The network-controlled sensor node 300 performs sensing of the object 400 in accordance with the obtained configuration.

The sensing might be performed via the NCSN S interface 360.

Embodiments relating to further details of the network-controlled sensor node 300 to be configured for sensing the object 400 as performed by the network-controlled sensor node 300 will now be disclosed with continued reference to FIG. 4.

As disclosed above, the supported at least one sensing mode might be any, or any combination, of: monostatic sensing, bistatic sensing, multi-static sensing.

As disclosed above, the supported at least one sensing technique might be any, or any combination, of: Time-of-Arrival based sensing, Time-Difference-of-Arrival based sensing, Angle-of-Arrival based sensing, Doppler frequency estimation based sensing, channel correlation based sensing, channel state information based sensing.

Further aspects of the sensing-related information will be disclosed next.

In some examples, the sensing-related information indicates whether the network-controlled sensor node 300 supports single-polarized, dual-polarized and/or alternating polarization sensing. With single-polarized sensing, the network-controlled sensor node 300 is only capable of receiving and/or transmitting sensing signals with one polarization for a given time instance. With dual-polarized sensing, the network-controlled sensor node 300 is capable of receiving and/or transmitting sensing signals with two orthogonal polarizations for a given time instance. With alternating polarization sensing, the transmit polarization and/or the receive polarization of the network-controlled sensor node 300 used for sensing can be dynamically changed.

In some examples, the sensing-related information indicates whether the network-controlled sensor node 300 supports only receiving sensing signals, only transmitting sensing signals or both transmitting and receiving the sensing signals.

In some examples, the sensing-related information indicates the type of the sensing signals that are supported by the network-controlled sensor node 300, for instance dedicated sensing signals such as any, or any combination of pulse signals, sinc signals (e.g., a single frequency pulse), chirp signals, and/or reference signals such as any, or any combination of demodulation reference signals (DMRS), channel state information signals (CSI-RS), sounding reference signals (SRS), synchronization signal blocks (SSB).

In some examples, the sensing-related information indicates information about beamforming capabilities. This may include information about, e.g., support of performing beam sweep when performing sensing, the number of beams in vertical dimension, the number of beams in horizontal dimension, the total number of beams, etc.

In some examples, the sensing-related information indicates information related to a capability of the network-controlled sensor node 300 to receive and/or transmit sensing signals in multiple beams, e.g., simultaneously receiving directly from the network node 200 as well as reflections from the object 400, respectively, possibly in different subcarriers. This would be helpful in assessing time-of-arrival or Doppler spread differences, in particular if the network-controlled sensor node 300 has, e.g., lower quality oscillators in which case the resulting frequency error may affect the sensing result. By receiving both the direct path and the indirect path simultaneously, an exact reference would be provided allowing for a more accurate sensing result.

In some examples, the sensing-related information indicates the network-controlled sensor node 300 processing delay of the sensing signal, i.e., how long it takes for the network-controlled sensor node 300 to process the received sensing signal before being able to send the information back to the network node 200.

Therefore, in some embodiments, the sensing-related information further specifies any, or any combination, of: polarization mode supported by the network-controlled sensor node 300, type of sensing signals supported by the network-controlled sensor node 300, sensing signal transmission/reception mode supported by the network-controlled sensor node 300, beamforming capabilities of the network-controlled sensor node 300, beam sweeping capabilities of the network-controlled sensor node 300.

In further embodiments, the sensing-related information further specifies any, or any combination, of: output power capabilities of the network-controlled sensor node 300, reception sensitivity of the network-controlled sensor node 300, processing delay of the network-controlled sensor node 300.

In further embodiments, the sensing-related information further comprises positioning information of the network-controlled sensor node 300.

In some examples, the sensing-related information indicates whether the network-controlled sensor node 300 supports periodic/semi-persistent and/or dynamic time indication for sensing, i.e., the network-controlled sensor node 300 can be configured with periodic, semi-persistent or dynamic time intervals when the network-controlled sensor node 300 should be used for receiving and/or transmitting sensing signals.

As disclosed above, in some embodiments, the configuration specifies which supported at least one sensing mode the network-controlled sensor node 300 is to use for sensing the object 400. As disclosed above, this configuration is not needed if the network-controlled sensor node 300 only supports one sensing mode.

As disclosed above, in some embodiments, the configuration specifies which supported at least one sensing technique the network-controlled sensor node 300 is to use for sensing the object 400. As disclosed above, this configuration is not needed if the network-controlled sensor node 300 only supports one sensing technique.

As disclosed above, in some embodiments, the configuration specifies time and/or frequency resource for the network-controlled sensor node 300 to use for sensing the object 400. As disclosed above, the one or more time and/or frequency resources to be used for the sensing can be represented by their starting point, ending point, periodicity, duration, etc.

As disclosed above, in some embodiments, the configuration specifies whether the network-controlled sensor node 300 is to transmit a signal for sensing the object 400, receive a signal for sensing the object 400, or transmit and receive a signal for sensing the object 400.

As disclosed above, in some embodiments, the configuration specifies a polarization mode to be used by the network-controlled sensor node 300 when sensing the object 400.

As disclosed above, in some embodiments, the configuration specifies a beam configuration to be used by the network-controlled sensor node 300 when sensing the object 400.

As disclosed above, in some examples, the configuration specifies information about the absolute and/or relative position of the network node 200 and/or the network-controlled sensor node 300. This information might, for example, be useful if the network-controlled sensor node 300 performs processing of the received sensing signals.

Further aspects of the sensing of the object as performed by the network-controlled sensor node 300 in S206 will be disclosed next. As disclosed above, the sensing is performed in accordance with the configuration obtained in S204.

In some aspects, the network-controlled sensor node 300 transmits a sensing signal which will be reflected by the object 400 and received by the network node 200. Hence, in some embodiments, the network-controlled sensor node 300 is configured to perform S206-2 as part of performing the sensing in S206.

S206-2: The network-controlled sensor node 300 transmits a sensing signal towards the object 400.

In some aspects, the network-controlled sensor node 300 receives a reflection of a sensing signal transmitted by the network node 200 and reflected by the object 400. The network-controlled sensor node 300 might then process the received sensing signal and report the related information to the network node 200. Hence, in some embodiments, the network-controlled sensor node 300 is configured to perform S206-4, S206-6, and S206-8 as part of performing the sensing in S206.

S206-4: The network-controlled sensor node 300 receives a sensing signal as having been reflected at the object 400.

S206-6: The network-controlled sensor node 300 extracts information by processing the received sensing signal. S206-8: The network-controlled sensor node 300 reports the extracted information to the network node 200.

As disclosed above, in some embodiments, the network-controlled sensor node 300 directly reports measurements on the received sensing signal back to the network node 200.

The sensing signal might in S206-2 and/or S206-4 be transmitted and/or received via a sensing interface (i.e., the NCSN S interface 360) at the network-controlled sensor node 300.

The report might in S206-8 be provided (and the configuration in S204 obtained) via a mobile termination interface i.e., the NCSN MT interface 350) at the network-controlled sensor node 300.

Regardless if the network-controlled sensor node 300 transmits or receives the sensing signal, the network-controlled sensor node 300 applies the configuration as obtained in S204. Hence, the network-controlled sensor node 300 might transmit or receive the sensing signal in one or more configured time and/or frequency resources using the configured sensing mode, sensing technique, polarization, beam configuration, etc.

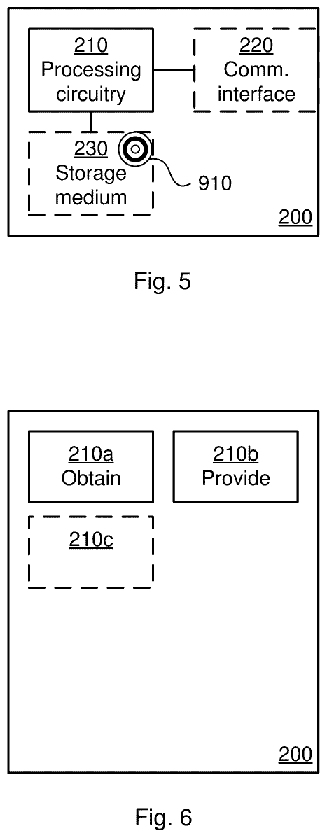

FIG. 5 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910a (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications (comm.) interface 220 for communications with other entities, functions, nodes, and devices, as illustrated in FIG. 1. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230.

Other components, as well as the related functionality, of the network node 200 are omitted in order not to obscure the concepts presented herein.

FIG. 6 schematically illustrates, in terms of a number of functional modules, the components of a network node 200 according to an embodiment. The network node 200 of FIG. 6 comprises a number of functional modules; an obtain module 210a configured to perform step S102, and a provide module 210b configured to perform step S104. The network node 200 of FIG. 6 may further comprise a number of optional functional modules, as represented by functional module 210c. In general terms, each functional module 210a: 210c may be implemented in hardware or in software. Preferably, one or more or all functional modules 210a: 210c may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210c and to execute these instructions, thereby performing any steps of the network node 200 as disclosed herein.

The network node 200 may be provided as a standalone device or as a part of at least one further device. For example, the network node 200 may be provided in a node of a radio access network or in a node of a core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 5 the processing circuitry 210 may be distributed among a plurality of devices, or nodes. The same applies to the functional modules 210a: 210c of FIG. 6 and the computer program 920a of FIG. 9.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

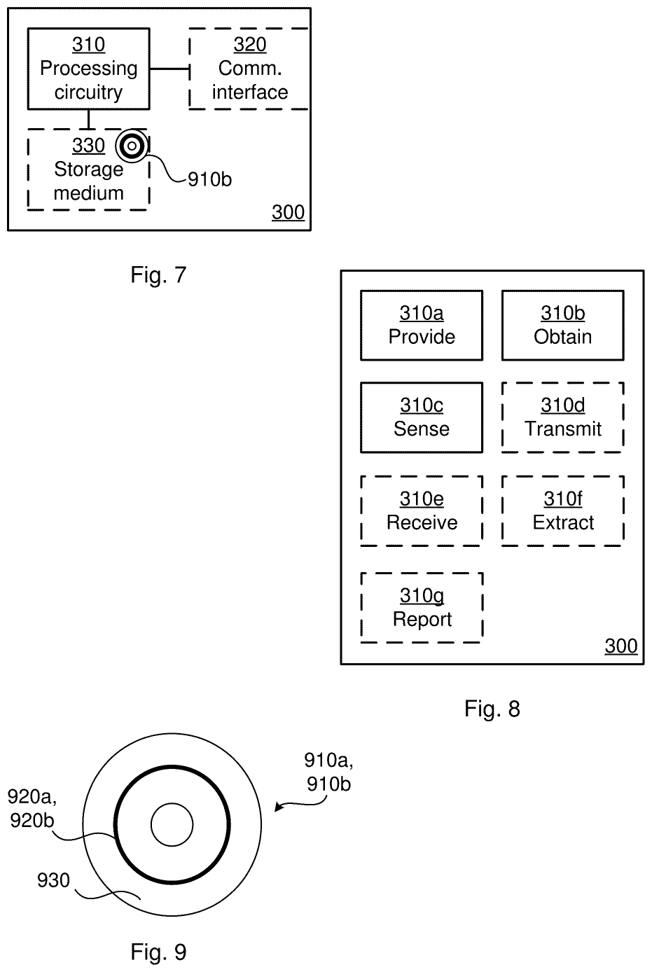

FIG. 7 schematically illustrates, in terms of a number of functional units, the components of a network-controlled sensor node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910b (as in FIG. 9), e.g. in the form of a storage medium 330. The processing circuitry 310 may further be provided as at least one application specific integrated circuit (ASIC), or field programmable gate array (FPGA).

Particularly, the processing circuitry 310 is configured to cause the network-controlled sensor node 300 to perform a set of operations, or steps, as disclosed above. For example, the storage medium 330 may store the set of operations, and the processing circuitry 310 may be configured to retrieve the set of operations from the storage medium 330 to cause the network-controlled sensor node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The network-controlled sensor node 300 may further comprise a communications interface 320 for communications with other entities, functions, nodes, and devices, as illustrated in FIG. 1. As such the communications interface 320 may comprise one or more transmitters and receivers, comprising analogue and digital components. In some examples, the communications interface 320 comprises, or implements, the NCSN MT interface 350 and the NCSN S interface 360.

The processing circuitry 310 controls the general operation of the network-controlled sensor node 300 e.g. by sending data and control signals to the communications interface 320 and the storage medium 330, by receiving data and reports from the communications interface 320, and by retrieving data and instructions from the storage medium 330. Other components, as well as the related functionality, of the network-controlled sensor node 300 are omitted in order not to obscure the concepts presented herein.

FIG. 8 schematically illustrates, in terms of a number of functional modules, the components of a network-controlled sensor node 300 according to an embodiment. The network-controlled sensor node 300 of FIG. 8 comprises a number of functional modules; a provide module 310a configured to perform step S202, an obtain module 310b configured to perform step S204, and a sense module 310c configured to perform step S206. The network-controlled sensor node 300 of FIG. 8 may further comprise a number of optional functional modules, such as any of a transmit module 310d configured to perform step S206-2, a receive module 310e configured to perform step S206-4, an extract module 310f configured to perform step S206-6, and a report module 310g configured to perform step S206-8. In general terms, each functional module 310a: 310g may be implemented in hardware or in software. Preferably, one or more or all functional modules 310a: 310g may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310g and to execute these instructions, thereby performing any steps of the network-controlled sensor node 300 as disclosed herein.

FIG. 9 shows one example of a computer program product 910a, 910b comprising computer readable means 930. On this computer readable means 930, a computer program 920a can be stored, which computer program 920a can cause the processing circuitry 210 and thereto operatively coupled entities and devices, such as the communications interface 220 and the storage medium 230, to execute methods according to embodiments described herein. The computer program 920a and/or computer program product 910a may thus provide means for performing any steps of the network node 200 as herein disclosed. On this computer readable means 930, a computer program 920b can be stored, which computer program 920b can cause the processing circuitry 310 and thereto operatively coupled entities and devices, such as the communications interface 320 and the storage medium 330, to execute methods according to embodiments described herein. The computer program 920b and/or computer program product 910b may thus provide means for performing any steps of the network-controlled sensor node 300 as herein disclosed.

In the example of FIG. 9, the computer program product 910a, 910b is illustrated as an optical disc, such as a CD (compact disc) or a DVD (digital versatile disc) or a Blu-Ray disc. The computer program product 910a, 910b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920a, 920b is here schematically shown as a track on the depicted optical disk, the computer program 920a, 920b can be stored in any way which is suitable for the computer program product 910a, 910b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for configuring a network-controlled sensor node for sensing an object, wherein the method is performed by a network node, and wherein the method comprises:
obtaining a report comprising sensing-related information of the network-controlled sensor node, wherein the sensing-related information at least specifies at least one sensing mode supported by the network-controlled sensor node and at least one sensing technique supported by the network-controlled sensor node; and
providing configuration to the network-controlled sensor node for the sensing of the object, wherein the configuration is based on the supported at least one sensing mode and at least one sensing technique.

2. The method according to claim 1, wherein the supported at least one sensing mode is any, or any combination, of: monostatic sensing, bistatic sensing, multi-static sensing.

3. The method according claim 1, wherein the supported at least one sensing technique is any, or any combination, of: Time-of-Arrival based sensing, Time-Difference-of-Arrival based sensing, Angle-of-Arrival based sensing, Doppler frequency estimation based sensing, channel correlation based sensing, channel state information based sensing.

4. The method according to claim 1, wherein the sensing-related information further specifies any, or any combination, of: polarization mode supported by the network-controlled sensor node, type of sensing signals supported by the network-controlled sensor node, sensing signal transmission/reception mode supported by the network-controlled sensor node, beamforming capabilities of the network-controlled sensor node, beam sweeping capabilities of the network-controlled sensor node.

5. The method according to claim 1, wherein the sensing-related information further specifies any, or any combination, of: output power capabilities of the network-controlled sensor node, reception sensitivity of the network-controlled sensor node, processing delay of the network-controlled sensor node.

6. The method according to claim 1, wherein the sensing-related information further comprises positioning information of the network-controlled sensor node.

7. The method according to claim 1, wherein the configuration specifies which supported at least one sensing mode the network-controlled sensor node is to use for sensing the object.

8. The method according to claim 1, wherein the configuration specifies which supported at least one sensing technique the network-controlled sensor node is to use for sensing the object.

9. The method according to claim 1, wherein the configuration specifies time and/or frequency resource for the network-controlled sensor node to use for sensing the object.

10. The method according to claim 1, wherein the configuration specifies whether the network-controlled sensor node is to transmit a signal for sensing the object, receive a signal for sensing the object, or transmit and receive a signal for sensing the object.

11. The method according to claim 1, wherein the configuration specifies a polarization mode to be used by the network-controlled sensor node when sensing the object.

12. The method according to claim 1, wherein the configuration specifies a beam configuration to be used by the network-controlled sensor node when sensing the object.

13. The method according to claim 1, wherein the report is obtained either from the network-controlled sensor node or from an operations, administration, and maintenance system.

14. A method for a network-controlled sensor node to be configured for sensing an object, wherein the method is performed by the network-controlled sensor node, and wherein the method comprises:
providing a report comprising sensing-related information of the network-controlled sensor node to a network node, wherein the sensing-related information at least specifies at least one sensing mode supported by the network-controlled sensor node and at least one sensing technique supported by the network-controlled sensor node;
obtaining configuration, from the network node, for the sensing of the object and
performing sensing of the object in accordance with the obtained configuration.

15. The method according to claim 14, wherein the supported at least one sensing mode is any, or any combination, of: monostatic sensing, bistatic sensing, multi-static sensing.

16. The method according to claim 14, wherein the supported at least one sensing technique is any, or any combination, of: Time-of-Arrival based sensing, Time-Difference-of-Arrival based sensing, Angle-of-Arrival based sensing, Doppler frequency estimation based sensing, channel correlation based sensing, channel state information based sensing.

17. The method according to claim 14, wherein the sensing-related information further specifies any, or any combination, of: polarization mode supported by the network-controlled sensor node, type of sensing signals supported by the network-controlled sensor node, sensing signal transmission/reception mode supported by the network-controlled sensor node, beamforming capabilities of the network-controlled sensor node, beam sweeping capabilities of the network-controlled sensor node.

18. The method according to claim 14, wherein the sensing-related information further specifies any, or any combination, of: output power capabilities of the network-controlled sensor node, reception sensitivity of the network-controlled sensor node, processing delay of the network-controlled sensor node.

19. The method according to claim 14, wherein the sensing-related information further comprises positioning information of the network-controlled sensor node.

20. The method according to claim 14, wherein the configuration specifies which supported at least one sensing mode the network-controlled sensor node, is to use for sensing the object.

21-38. (canceled)
